(19) United States
(12) Patent Application Publication
(10) Pub. No.: US 2017/0144066 A1
(43) Pub. Date: May 25, 2017

(54) DISTRIBUTION SYSTEM AND METHOD

(71) Applicant: CAPCOM CO., LTD., Osaka (JP)

(72) Inventor: Koji HASUNUMA, Osaka (JP)

(73) Assignee: CAPCOM CO., LTD., Osaka (JP)

(21) Appl. No.: 15/316,675

(22) PCT Filed: Mar. 12, 2015
(86) PCT No.: PCT/JP2015/057321

§ 371 Date: Dec. 6, 2016

(30) Foreign Application Priority Data
Jun. 9, 2014 (JP) 2014-118502

(51) Int. Cl. A63F 13/35

(52) U.S. Cl. CPC A63F 13/35

(57) ABSTRACT

A loads counting unit 12 counts loads applied to a distribution server 1 during a counting period. A benefit provision unit 13 extracts the counting period in which the loads was lower during a counting term and provides a benefit to users who have downloaded during the extracted counting period. Consequently, it can be expected that the game program is downloaded in the time zone with a lower amount of the loads and it is possible to reduce the peak load applied to the distribution server 1.

### TECHNICAL FIELD

The present invention relates to a technique for distributing contents.

### BACKGROUND OF THE INVENTION

As bandwidth of network becomes broader and online games become more popular, downloading game programs via network has been widespread.

When a game program is downloaded from a distribution server, access to the distribution server is concentrated on the release date of the game. Therefore it is necessary to strengthen the distribution server and network lines. The number of access to the distribution server is large at the beginning of the release, and the number of access decreases sharply as the days pass from the release date of the game.

In the case of an online game, a user cannot play the game until the online game service starts, even if the game program has been downloaded. Therefore it is possible to disperse the access to the distribution server by enabling the download of the game program before the online game service starts.

However, even if the game program can be downloaded before the game service starts, there is a problem that the access to the distribution server is concentrated right after downloading is enabled or in the time zone from night to late at night on the release day. Japanese Laid-Open Patent Application Publication No. 2014-048832 discloses a technique that accepts preregistration before releasing an application software and provides the benefit after releasing the application software. The download start time of the application software is the same as the service start time of the application. And the problem, which the access to the distribution server is concentrated, is not considered.

### SUMMARY OF THE INVENTION

The present invention is aimed to reduce the peak load applied to the distribution server for downloading the contents.

A distribution system according to the present invention has a distributing unit, a loads counting unit, a benefit provision unit. The distributing unit distributes contents in response to requests from users. The loads counting unit counts loads which are applied to the distributing unit for each counting period during a counting term. The benefit provision unit provides a benefit to the users who have downloaded the contents during the counting period with a lower amount as a result of counting the loads by the loads counting unit.

According to the present invention, the load counting unit counts loads applied to the distribution unit for each counting period during the counting term, and the benefit provision unit provides the benefit to the users who have downloaded the contents during the counting period with a lower amount as a result of counting the loads. Consequently, it can be expected that the contents are downloaded in the time zone in which the loads applied to the distribution unit are lower. As a result, it is possible to reduce the peak load applied to the distribution server for downloading the contents.

### BRIEF DESCRIPTION OF THE DRAWINGS

FIG. 1 is an overall configuration diagram showing a distribution system according to one embodiment of the present invention.

FIG. 2 is a graph showing the relation between a counting term and increase/decrease in the loads.

### DESCRIPTION OF EMBODIMENTS

Hereinafter, an embodiment of the present invention will be described with reference to drawings.

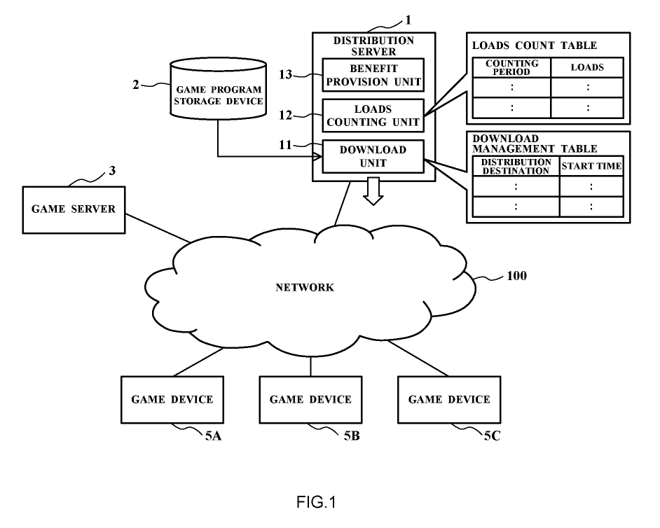

FIG. 1 is an overall configuration diagram of a distribution system according to the present embodiment. A distribution system shown in FIG. 1 includes a distribution server 1, a game program storage device 2, and a game server 3. Game devices 5A-5C operated by users are connected to the distribution server 1 and the game server 3 via a network 100. The distribution server 1 is connected to the game program storage device 2 and distributes the game program to the game devices 5A-5C via the network 100 in response to the requests from the game devices 5A-5C. The game server 3 provides a game service to the game devices 5A-5B that execute the game program.

The distribution system according to the present embodiment is a system that sets a certain term during a download period in which the game program can be downloaded as a counting term and counts the loads applied to the distribution server 1 for each counting period, and that provides the benefit to users who have downloaded the game program during the counting period with a lower amount of the loads. Here, the counting term is divided into a plurality of the counting periods. Hereinafter, the distribution server 1 will be described.

The distribution server 1 according to the present embodiment includes a download unit 11, a loads counting unit 12, and a benefit provision unit 13. Each unit of the distribution server 1 may be configured by a computer having a calculation processing device, a storage device or the like. And the processing of each unit may be executed by a server program. The server program may be stored in the storage device included in the distribution server 1. Also, the server program may be stored in a storage medium such as a magnetic disk, an optical disk or a semiconductor memory and also maybe provided via the network 100.

A download unit 11 accepts a download request of the game program from the game devices 5A-5C and determines whether or not to distribute the game program by performing the user authentication process, the accounting process and the like. And the download unit 11 distributes the game program stored in the game program storage device 2 to the game device 5A-5C. The download unit 11 manages the distribution destination where the game program was distributed and the download start time by using a download management table. For example, the information of the distribution destination may be an ID for identifying the user used in a user authentication process or an ID for identifying the game device provided to each of the game devices 5A-5C. An account for the game service provided by the game server 3 may be used as the information of the distribution destination. The download unit 11 registers the time when the distribution of the game program starts, as the start time. The download unit 11 may register the time when the distribution of the game program has completed or information indicating whether the distribution has succeeded or failed to the download table.

The loads counting unit 12 counts the loads applied to the distribution server 1 for each predetermined counting period during the designated counting term and manages the counted loads with a loads count table. The loads counted for each counting period are described in the loads count table. For example, it is possible to use the number of the users who are downloading the contents, the loads applied to the distribution server 1 (usage rate of resources such as a CPU and a memory) and the bandwidth usage rate of the line to which the distributing server 1 is connected, as the loads to be counted.

After the counting term, the benefit provision unit 13 decides counting periods with a lower amount as a result of counting loads with reference to the loads count table. The benefit provision unit 13 extracts the distribution destination which has started downloading during the counting period with a lower amount of the loads with reference to the download management table. And the benefit provision unit 13 provides the benefit to the extracted distribution destination. For example, the benefit may be data that can be used in another game. Alternatively, the benefit may be digital data that cannot be available in the game, such as wallpaper, a ring tone and a discount ticket. The digital data is not limited to data which is used in the game distributed by the distribution system and may be data that can be used in another game. The benefit maybe the goods related to the game. In this case, the benefit provision unit 13 distributes goods to the address of the user associated with the distribution destination where the benefit will be provided.

Next, the operation of the distribution system in the present embodiment will be described.

The download process will be described, first.

When the game program becomes downloadable, the user can access the distribution server 1 with the game devices 5A-5C and request the download of the game program. The download request that the game devices 5A-5C send to the distribution server 1 includes an ID for identifying the user or an ID for identifying the game devices 5a-5C. The download request may include accounts used in the game server 3.

When receiving the download request from the game devices 5A-5C, the download unit 11 performs an authentication process by using the ID included in the download request. If payment is necessary, confirmation of the payment status by the user and the accounting process will be performed. If user registration is necessary, confirmation of whether or not the user is registered and the user registration process will be performed. The registered user information may be used as an account used in the game server 3.

When the authentication process and the like have been completed, the download unit 11 reads out the game program from the game program storage device 2 and distributes the game program to the game devices 5A-5C and registers the information of the distribution destination and the start time of downloading to the download management table.

There is a case that the size of the game program exceeds tens of gigabytes, and also there is a case that it takes several hours to download the game program depending on the situation. When downloading has been completed, the download unit 11 cuts off the connection among the game devices 5A-5C.

Next, a loads count process will be described.

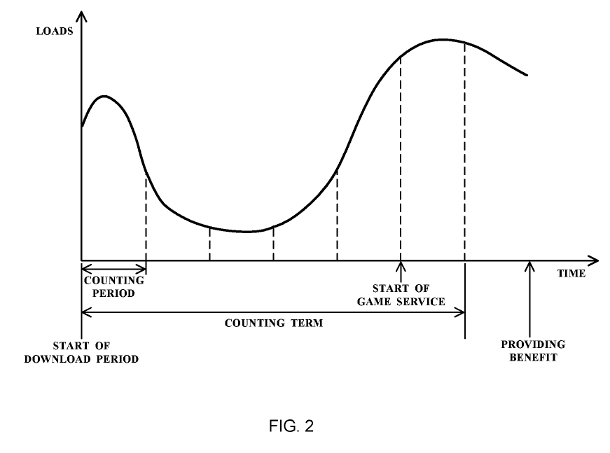

FIG. 2 is a graph showing the relation between the counting term and increase/decrease in the loads. In the example in the FIG. 2, the download period starts before the game service starts. The counting term lasts from the start of the download period until after the start of the game service. The benefit is provided after the end of the counting term. As a specific example, the start of the download period is one week before the start of the game service. The counting term is for ten days from the start of download period. The benefit will be provided after four days after the counting term has finished. The counting period is for four hours. These numerical values are merely examples and are set based on the scale and situation of the game. For example, in the case that it is desired to suppress the number of download right after the download period starts or right after the game server 3 starts to work, the counting term may start after a while from the start of the download period and may finish before the game server starts.

The user can know the start time of download period, the start time of the game service and the counting term through web-sites of the game and the like, in advance. The user is notified that the benefit will be provided in the case that the user has downloaded the game when the loads applied to the distribution server 1 is lower during the counting term.

When the download period starts and the user downloads the game program from the distribution server 1, the loads applied to the distribution server 1 changes according to the number of the users who are downloading the game program. It is assumed that the loads applied to the distribution server 1 is higher right after the start of the download period or before and after the start of the game service. In one day, it is assumed that the loads are high from night to late night and are low in early morning.

The loads counting unit 12 sums up the counted loads for each counting period and registers the counting period and the summed loads to the loads count table. As the way of counting the loads, there is a way of calculating the average, maximum value and mode of the loads during the counting period, and there is a way of determining the loads at a predetermined timing within the counting period, as the loads during the counting term.

Subsequently, the benefit process will be described.

When the counting term finishes, the benefit provision unit 13 refers to the loads count table and extracts the counting period with a lower amount of the loads. The benefit provision unit 13 may extract a predetermined number of the counting period in ascending order of the loads or may extract all of the counting period in which the amount of the loads is a predetermined threshold or less. The benefit provision unit 13 may extract the counting period in ascending order of the loads until the number of the users who can get the benefit reaches a predetermined number.

Then, the benefit provision unit 13 refers to the download management table and extracts the distribution destination in which the download has been started during the extracted counting period. The benefit provision unit 13 may extract the distribution destination in which the extracted counting period overlaps the term from the start to the end of download even slightly.

When the benefit providing timing comes, the benefit provision unit 13 provides the benefit to the extracted distribution destination. In the case that the benefit is digital data that can be used in the game, the distribution destination and the account of the game will be associated with each other, and the benefit provision unit 13 will provide the benefit to the account. For example, the benefit provision unit 13 accesses the game server 3 and provides the benefit to the corresponding account. Alternatively, the benefit provision unit 13 may let the corresponding account know an item code by a message or the like, and the user may get the benefit after the user has input the item code in the game.

In the above description, the example in which the download period starts before the game service starts is described. However, the present invention can be applied to the case that the download period starts at the same time the game service starts. Furthermore, the present invention can be applied to not only the start time of the regular game service but also when the game program used in the p test in which the game service test is carried out for limited people is distributed. The present invention can be applied to the distribution of update data in the case of an update after the game service starts as well.

According to the present embodiment described above, the loads counting unit 12 counts loads applied to the distribution server for each counting period. The benefit provision unit 13 extracts the counting period in which the loads were lower during the counting term and provides the benefit to the users who have downloaded the game program during the extracted counting period. Consequently, it can be expected that the game program is downloaded in the time zone with a lower amount of the loads, and it is possible to reduce the peak load applied to the distribution server 1. Furthermore, users can download the game program in a short time by downloading the game program during the counting period with a lower amount of the loads.

### AVAILABLITY OF INDUSTRIES

As described above, according to the present invention, it is possible to reduce the peak load applied to the distribution server for downloading contents.

1. A distribution system comprising:
a distributing unit distributing contents in response to requests from users;
a loads counting unit counting loads which are applied to the distributing unit for each counting period during a counting term, the counting term being divided into a plurality of the counting periods; and
a benefit provision unit providing a benefit to the users who have downloaded the contents during the counting period with a lower amount as a result of counting the loads by the loads counting unit.

2. The distribution system according to claim 1,
wherein the benefit provision unit provides the benefit to the users who have downloaded the contents during the counting period in which the amount of the loads is a predetermined threshold or less.

3. The distribution system according to claim 1,
wherein the benefit provision unit extracts the counting period in ascending order of the loads after the load counting unit has finished counting the loads and provides the benefit to the users who have downloaded the contents during the extracted counting period until the number of the users to whom the benefit provision unit provides the benefit reaches a predetermined number.

4. The distribution system according to claim 1,
wherein the loads counting unit counts at least any one item of the number of the users who are downloading the contents, loads applied to the distributing unit, and usage rate of line bandwidth to which the distributing unit is connected, as the loads.

5. A method of distributing contents comprising:
a distributing step distributing contents in response to requests from users;
a loads counting step counting loads which is applied in the distributing step for each counting period during a counting term, the counting term being divided into a plurality of the counting periods; and
a benefit provision step providing a benefit to the users who have downloaded the contents during the counting period with a lower amount as a result of counting the loads in the loads counting step.

6. The method according to claim 5,
wherein the benefit provision step provides the benefit to the users who have downloaded the contents during the counting period in which the amount of the loads is a predetermined threshold or less.

7. The method according to claim 5,
wherein the benefit provision step extracts the counting period in ascending order of the loads after the loads counting step has finished counting the loads and provides the benefit to the users who have downloaded the contents during the extracted counting period until the number of the users who have been provided the benefit in the benefit provision step reaches a predetermined number.

8. The method according to claims 5,
wherein the loads counting step counts at least any one item of the number of the users who have been downloading the contents, loads in the distributing step, and usage rate of bandwidth of line in the distributing step, as the loads.
